(19) United States
(12) Patent Application Publication
(10) Pub. No.: US 2026/0030147 A1
(43) Pub. Date: Jan. 29, 2026

(54) METHODS, SYSTEMS, AND MEDIA FOR AUTOMATED DEEPLINK VALIDATION FOR MEDIA APPLICATIONS INSTALLED ON A NETWORK-CONNECTED TELEVISION DEVICE

(71) Applicant: GOOGLE LLC, Mountain View, CA (US)

(72) Inventors: Vivek Yadav, Bangalore (IN); Saurabh Joshi, Zurich (CH); Rahul Arora, San Francisco, CA (US); Vineet Kumar, Bangalore (IN); Sandeep Khunteta, Bangalore (IN)

(21) Appl. No.: 19/144,318

(22) PCT Filed: Dec. 29, 2022
(86) PCT No.: PCT/US2022/054248

§ 371 Date: Jun. 27, 2025

(51) Int. Cl. G06F 11/3698; H04N 21/25; H04N 21/482

(52) U.S. Cl. CPC G06F 11/3698; H04N 21/25; H04N 21/482

(57) ABSTRACT

Methods, systems, and media for automated application validation of media applications installed on a network-connected television device are provided. In some implementations, the methods comprise: receiving, at a server device, a media application for presenting video content, wherein the video content is associated with a plurality of media actions that are presented in one or more unified user interfaces of a unified television application executing on a network-connected television device; testing, at the server device, the media application using a plurality of validators, wherein the plurality of validators each test a portion of the plurality of media actions presented on the one or more unified user interfaces of the unified television application, wherein the plurality of validators includes a first validator that determines whether a deeplink associated with the video content that is available for presentation using the network-connected television application is operating correctly, and wherein the deeplink, upon selection, causes the media application to launch and cause the media application to retrieve and play back a corresponding video content item; determining, using the first validator, a plurality of deeplinks that are associated with the video content that is available for presentation using the media application; determining, using the first validator, whether selection of each of the plurality of deeplinks causes the media application to launch and cause the media application to retrieve and play back the corresponding video content item; and, in response to determining that a subset of the plurality of deeplinks are operating incorrectly, transmitting, at the server device, a notification to the content partner that the subset of the plurality of deeplinks is operating incorrectly while causing the unified television application to suppress recommendations that include a deeplink from the subset of the plurality of deeplinks that are operating incorrectly.

### TECHNICAL FIELD

The disclosed subject matter relates to methods, systems, and media for automated application validation of media applications installed on a network-connected television device.

### BACKGROUND

Media display devices, such as television devices and other large screen devices, provide users with the ability to install third-party applications. These third-party applications can include applications for a particular over-the-top content source that, when executed, allow a user to navigate through various media items or receive media recommendations for various media items available from the over-the-top content source. In response to receiving a selection of a media item, the third-party application can retrieve the selected media item from the over-the-top content source and perform media playback of the selected media item on the media display device.

In building third-party applications for use on a media display device, application developers typically provide the third-party application and associated files for review and approval by a media display device platform that manages the operating system executing on the media display device. This media display device platform can determine whether the third-party application meets various technical and/or quality criteria for the platform. In response to an administrative user at the media display device platform manually reviewing the third-party application, the application developer may receive a notification regarding information about why the third-party application was not approved for use with the media display device platform and/or information about issues with the third-party application that need to be addressed prior to being discoverable and/or downloadable by users of the media display device platform. Such review of a third-party application is often a time-consuming experience requiring many back and forth communications with an administrative user at the media display device platform, thereby delaying the release or availability of the third-party application on the media display device platform.

Accordingly, it is desirable to provide methods, systems, and media for automated application validation of media applications installed on a network-connected television device.

### SUMMARY

In accordance with some implementations of the disclosed subject matter, methods, systems, and media for automated application validation of media applications installed on a network-connected television device are provided.

In accordance with some implementations of the disclosed subject matter, a method for media application validation is provided, the method comprising: receiving, at a server device having a hardware processor, a media application for presenting video content, wherein the media application is associated with a content partner and wherein the video content is associated with a plurality of media actions that are presented in one or more unified user interfaces of a unified television application executing on a network-connected television device; testing, at the server device, the media application using a plurality of validators, wherein the plurality of validators each test a portion of the plurality of media actions presented on the one or more unified user interfaces of the unified television application, wherein the plurality of validators includes a first validator that determines whether a deeplink associated with the video content that is available for presentation using the network-connected television application is operating correctly, and wherein the deeplink, upon selection, causes the media application to launch and cause the media application to retrieve and play back a corresponding video content item; determining, using the first validator, a plurality of deeplinks that are associated with the video content that is available for presentation using the media application, wherein each of the plurality of deeplinks is presented on one or more unified user interfaces of the unified television application executing on the network-connected television device; determining, using the first validator, whether selection of each of the plurality of deeplinks causes the media application to launch and cause the media application to retrieve and play back the corresponding video content item; and, in response to determining that a subset of the plurality of deeplinks are operating incorrectly by not launching the media application and not causing the media application to retrieve and playback the corresponding video content item, transmitting, at the server device, a notification to the content partner that the subset of the plurality of deeplinks is operating incorrectly while causing the unified television application to suppress recommendations that include a deeplink from the subset of the plurality of deeplinks that are operating incorrectly.

In some embodiments, the notification to the content partner further includes an indication of remaining deeplinks that are operating correctly.

In some embodiments, the unified television application presents the recommendations that include one of the remaining deeplinks that are operating correctly.

In some embodiments, the plurality of validators includes a second validator that determines whether to present one or more video tiles in a row of video tiles within the unified television application for a user having a user account that is authenticated with the unified television application to consume the corresponding video content at a later time.

In some embodiments, the one or more video tiles in the row of video tiles corresponds to at least one of a video content item that the user has indicated as being of interest and a video content item that is related to content that the user has consumed.

In some embodiments, the method further comprises determining whether selection of a video tile in the row of video tiles causes the media application to launch and causes the media application to retrieve and play back the video content item corresponding to the video tile.

In some embodiments, the method further comprises determining that the content that the user has consumed is episodic content and determining that the video content item is a subsequent episode of the content that the user has consumed.

In some embodiments, the one or more video tiles in the row of video tiles corresponds to video content items that the user has stopped viewing prior to an end time of the video content item.

In some embodiments, the method further comprises determining whether selection of a video tile in the row of video tiles causes the media application to launch and cause the media application to retrieve and play back the video content item corresponding to the video tile from a playback position that corresponds to when the user stopped viewing the video content item.

In some embodiments, the plurality of validators includes a third validator that determines whether the media party application transmits an indication of media playback to the unified television application.

In accordance with some implementations of the disclosed subject matter, a system for media application validation is provided, the system comprising a server device that includes a hardware processor, wherein the hardware processor is configured to: receive, at a server device, a media application for presenting video content, wherein the media application is associated with a content partner and wherein the video content is associated with a plurality of media actions that are presented in one or more unified user interfaces of a unified television application executing on a network-connected television device; test, at the server device, the media application using a plurality of validators, wherein the plurality of validators each test a portion of the plurality of media actions presented on the one or more unified user interfaces of the unified television application, wherein the plurality of validators includes a first validator that determines whether a deeplink associated with the video content that is available for presentation using the network-connected television application is operating correctly, and wherein the deeplink, upon selection, causes the media application to launch and cause the media application to retrieve and play back a corresponding video content item; determine, using the first validator, a plurality of deeplinks that are associated with the video content that is available for presentation using the media application, wherein each of the plurality of deeplinks is presented on one or more unified user interfaces of the unified television application executing on the network-connected television device; determine, using the first validator, whether selection of each of the plurality of deeplinks causes the media application to launch and cause the media application to retrieve and play back the corresponding video content item; and, in response to determining that a subset of the plurality of deeplinks are operating incorrectly by not launching the media application and not causing the media application to retrieve and playback the corresponding video content item, transmit, at the server device, a notification to the content partner that the subset of the plurality of deeplinks is operating incorrectly while causing the unified television application to suppress recommendations that include a deeplink from the subset of the plurality of deeplinks that are operating incorrectly.

In accordance with some implementations of the disclosed subject matter, a non-transitory computer-readable medium containing computer executable instructions that, when executed by a processor, cause the processor to perform a method for media application validation is provided, the method comprising: receiving, at a server device, a media application for presenting video content, wherein the media application is associated with a content partner and wherein the video content is associated with a plurality of media actions that are presented in one or more unified user interfaces of a unified television application executing on a network-connected television device; testing, at the server device, the media application using a plurality of validators, wherein the plurality of validators each test a portion of the plurality of media actions presented on the one or more unified user interfaces of the unified television application, wherein the plurality of validators includes a first validator that determines whether a deeplink associated with the video content that is available for presentation using the network-connected television application is operating correctly, and wherein the deeplink, upon selection, causes the media application to launch and cause the media application to retrieve and play back a corresponding video content item; determining, using the first validator, a plurality of deeplinks that are associated with the video content that is available for presentation using the media application, wherein each of the plurality of deeplinks is presented on one or more unified user interfaces of the unified television application executing on the network-connected television device; determining, using the first validator, whether selection of each of the plurality of deeplinks causes the media application to launch and cause the media application to retrieve and play back the corresponding video content item; and, in response to determining that a subset of the plurality of deeplinks are operating incorrectly by not launching the media application and not causing the media application to retrieve and playback the corresponding video content item, transmitting, at the server device, a notification to the content partner that the subset of the plurality of deeplinks is operating incorrectly while causing the unified television application to suppress recommendations that include a deeplink from the subset of the plurality of deeplinks that are operating incorrectly.

In accordance with some implementations of the disclosed subject matter, a system for media application validation is provided, the system comprising: means for receiving a media application for presenting video content, wherein the media application is associated with a content partner and wherein the video content is associated with a plurality of media actions that are presented in one or more unified user interfaces of a unified television application executing on a network-connected television device; means for testing the media application using a plurality of validators, wherein the plurality of validators each test a portion of the plurality of media actions presented on the one or more unified user interfaces of the unified television application, wherein the plurality of validators includes a first validator that determines whether a deeplink associated with the video content that is available for presentation using the network-connected television application is operating correctly, and wherein the deeplink, upon selection, causes the media application to launch and cause the media application to retrieve and play back a corresponding video content item; means for determining, using the first validator, a plurality of deeplinks that are associated with the video content that is available for presentation using the media application, wherein each of the plurality of deeplinks is presented on one or more unified user interfaces of the unified television application executing on the network-connected television device; means for determining, using the first validator, whether selection of each of the plurality of deeplinks causes the media application to launch and cause the media application to retrieve and play back the corresponding video content item; and means for transmitting a notification to the content partner that the subset of the plurality of deeplinks is operating incorrectly while causing the unified television application to suppress recommendations that include a deeplink from the subset of the plurality of deeplinks that are operating incorrectly in response to determining that a subset of the plurality of deeplinks are operating incorrectly by not launching the media application and not causing the media application to retrieve and playback the corresponding video content item.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is an example media environment in which a network-connected television device, a server system, and third-party content sources interact with each other via one or more communication networks in accordance with some implementations of the disclosed subject matter.

FIG. 2 is an example operating environment in which a server system can provide knowledge-based media content recommendations to a network-connected television device in accordance with some implementations of the disclosed subject matter.

FIG. 3 is an example unified user interface for display on a network-connected television device in accordance with some implementations of the disclosed subject matter.

FIG. 4 is an example flow chart of a method of automated media validation of a media application for use with a unified television application executing on a network-connected television device in accordance with some implementations of the disclosed subject matter.

FIG. 5A is a block diagram illustrating a server system of a media environment in accordance with some implementations of the disclosed subject matter.

FIG. 5B is an example device and application registry of a server system that stores information of one or more user accounts managed by the server system and information of user devices and applications associated with each of the one or more user accounts in accordance with some implementations of the disclosed subject matter.

FIG. 6 is a block diagram illustrating an example network-connected television device configured to display a unified user interface and media content provided by media player applications in accordance with some implementations of the disclosed subject matter.

### DETAILED DESCRIPTION

In accordance with some implementations, mechanisms (which can include methods, systems, and media) for automated application validation of media applications installed on a network-connected television device.

Generally speaking, a validation system that includes multiple validators can be provided, where each validator can test the media integration of a media application provided by a content partner. For example, each validator can test a subset of media actions presented on one or more unified user interfaces of a unified television application executing on the network-connected television device. It should be noted that the multiple validators of the validation system can test the media application at any suitable time, such as prior to allowing the media application to be made available for installation and use on a network-connected television device or at predetermined time periods to ensure that the media integration of the media application continues to operate correctly (e.g., given the changing state of a unified television application that executes on the network-connected television device and that operates in connection with the media application). In response to the automated testing of the media application using one or more of the validators determining that an issue or error exists that inhibits the validation of the media application, the validation system can transmit notifications to the content partner concerning the issue and/or error that inhibits the validation of the media application (e.g., prior to transmitting the media application for validation and approval by a server system that manages the unified television application or any other suitable platform that allows the installation of media applications on the network-connected television device). Alternatively, in response to the automated testing of the media application using one or more of the validators determining that no issues or errors exist that inhibit the validation of the media application, the media application or a validation approval of the media application can be transmitted to a server system that manages a unified television application, where the media application can then be made available for installation and use on the network-connected television device.

In some implementations, the validation system can include any suitable number of validators.

For example, one of the multiple validators can include a first validator that determines whether a deeplink associated with video content that is available for presentation using the media application is operating correctly. Such a deeplink being presented on a unified user interface of a unified television application, upon selection, can cause the media application to launch and can cause the media application to retrieve and play back the corresponding video content item. In continuing this example, the first validator can determine whether selection of one or more of the deeplinks causes the media application to launch and causes the media application to retrieve and play back the corresponding video content item. In response to determining that a deeplink is operating incorrectly by not launching the media application and/or not causing the media application to retrieve and playback the corresponding video content item, the validation system can transmit a notification to the content partner that provided by the media application for use with the unified television application, where the notification indicates that one or more deeplinks in the unified television application are operating incorrectly. Such a notification can include, for example, one or more error codes that resulted from the automated testing using the first validator, a detailed description of issues in the media integration of the media application with the unified television application, a screenshot of the unified user interface in which the incorrectly operating deeplink appears, etc.). In some implementations, the notification can include an indication of the remaining deeplinks that are operating correctly. Additionally or alternatively, the validation system can provide suggestions to the content partner on how to address the deeplink issues inhibiting the media application from being validated or otherwise approved for use with the unified television application (e.g., based on error codes issued by the first validator). In instances in which the media application has been installed on the network-connected television device or is otherwise available for use by the unified television application, the validation system can cause the unified television application to suppress content recommendations and other suitable notifications that include the deeplink from being presented by the unified television application.

In another example, one of the multiple validators can include a second validator that determines whether to present one or more video tiles in a row of video tiles corresponding to the video content items available using the media application within the unified television application for a user having a user account that is authenticated with the unified television application to consume the corresponding video content at a later time. The one or more video tiles in the row of video files can correspond to a video content item that the user has indicated as being of interest, can correspond to a video content item that is related to content that the user has consumed, etc. In continuing this example, the second validator can determine whether selection of a video tile in the row of video tiles causes the media application to launch and causes the media application to retrieve and play back the video content item corresponding to the video tile. Additionally or alternatively, the second validator can determine that the video content that the user has consumed is episodic content and can determine that the video content item represented by the video tile is a subsequent episode of the video content item that the user has consumed (e.g., the next episode in a series). Additionally or alternatively, the second validator can determine that one or more video tiles in the row of video tiles corresponds to video content items that the user has stopped viewing prior to an end time of the video content item and can determine whether selection of a video tile in the row of video tiles causes the media application to launch and cause the media application to retrieve and play back the video content item corresponding to the video tile from a playback position that corresponds to when the user previously stopped viewing the video content item. In response to determining that a video tile is operating incorrectly by not launching the media application and/or not causing the media application to retrieve and playback the corresponding video content item (e.g., at the correct playback position), the validation system can transmit a notification to the content partner that provided by the media application for use with the unified television application, where the notification indicates that one or more video tiles in the unified television application are operating incorrectly. Such a notification can include, for example, one or more error codes that resulted from the automated testing using the second validator, a detailed description of issues in the media integration of the media application with the unified television application, a screenshot of the unified user interface in which the incorrectly operating video tile appears, etc.). In some implementations, the notification can include an indication of the remaining video tiles that are operating correctly. Additionally or alternatively, the validation system can provide suggestions to the content partner on how to address the video tile or media playback issues inhibiting the media application from being validated or otherwise approved for use with the unified television application (e.g., based on error codes issued by the second validator). In instances in which the media application has been installed on the network-connected television device or is otherwise available for use by the unified television application, the validation system can cause the unified television application to suppress content recommendations and other suitable notifications that include the video tiles from being presented by the unified television application (e.g., exclude the row of video tiles that is associated with a content source or a content partner from being presented on the unified user interface of the unified television application).

In yet another example, one of the multiple validators can include a third validator that determines whether the media application transmits an indication of media playback to the unified television application. For example, the third validator can determine, for a media playback session in which a user having an authenticated user account is consuming media content via the unified television application on the network-connected television device, whether the media application transmits indications of media playback to the unified television application. Such indications can include, for example, a content identifier, a source identifier, a playback position, a start time, content metadata, etc. In response to determining that the media application is operating incorrectly by not transmitting media playback indications to the unified television application, the validation system can transmit a notification to the content partner that provided by the media application for use with the unified television application, where the notification indicates that media application is not correctly passing media playback information to the unified television application. In instances in which the media application has been installed on the network-connected television device or is otherwise available for use by the unified television application, the validation system can cause the unified television application to suppress content recommendations and other suitable notifications provided by the media application from being presented by the unified television application (e.g., exclude the row of video tiles that is associated with a content source or a content partner from being presented on the unified user interface of the unified television application).

It should be noted that the validation system can update the one or more validators at any suitable time. For example, in some implementations, additional validators for automatically testing media applications and the media actions corresponding to the media applications in the unified television application can be added—e.g., a validator that determines whether caption information is being correctly presented by the media application based on location information associated with the network-connected television device. In another example, in some implementations, an updated validator for automatically testing media applications and the media actions corresponding to the media applications in the unified television application can replace one of the validators in the validation system, such as an updated deeplink validator.

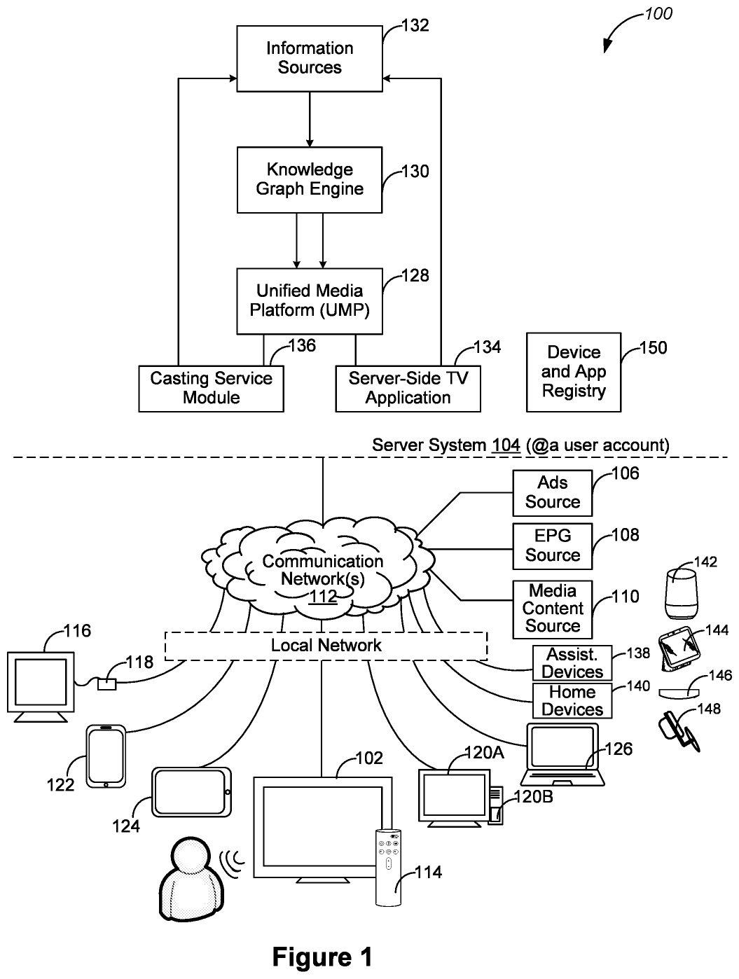

These and other features for automated application validation of media applications installed on a media device are further described in connection with FIGS. 1-6.

Turning to FIG. 1, FIG. 1 is an example media environment 100 in which a network-connected television device 102, a server system 104 and third-party content sources 106-110 interact with each other via one or more communication networks 112 in accordance with some implementations. The media environment 100 corresponds to a virtual user domain created and hosted by the server system 104, and the virtual user domain includes a plurality of user accounts. The third-party content sources 106-110 includes ads sources 106, EPG sources 108, and media content sources 110. For each user account, the server system 104 is coupled to the third-party content sources 106-110 and one or more media devices 102 and 116-126, and is configured to recommend and stream media content for review by a user via the respective user account.

Specifically, the one or more media devices associated with the user and the user account are disposed in the media environment 100 to provide the user with media content that is stored at and streamed from a remote content source. The remote content source is optionally a third-party media content source 110 or an internal media source hosted by the server system 104. In some implementations, the one or more media devices include the network-connected television device 102 which directly streams the media content from the remote content source or integrates an embedded casting unit configured to stream the media content for display to its audience. The network-connected television device 102 is communicatively coupled to a dedicated remote control device 114 and/or a client device having a remote control application. The dedicated remote control device 114 may be disposed in proximity to the television device 102 and configured to communicate with the television device 102 with digitally-coded pulses of infrared signals. Alternatively, in some situations, the dedicated remote control device 114 is configured to communicate with the television device 102 via the communication networks 112 (i.e., via a local wide area network and/or a wide area network), and does not have to be physically in proximity to the television device 102.

The network-connected television device 102 includes one or more processors and memory storing instructions for execution by the one or more processors. The instructions stored on the network-connected television device 102 include a unified television application, a local content casting application, and one or more media player applications associated with the third-party content sources 106-110 and/or internal media source associated with the server system 104. These applications are linked to the user account in the virtual user domain of the media environment 100.

Alternatively, in some implementations, the media devices disposed in the media environment 100 include a display device 116 that directly outputs the media content to the audience and a casting device 118 that is coupled to and configured to stream the media content to the display devices 116. Examples of the display device 116 include, but are not limited to, television (TV) display devices and music players. Examples of the casting device 118 include, but are not limited to, set-top boxes (STBs), DVD players and television boxes. In this example shown in FIG. 1, the display device 116 includes a television display that is hard wired to a DVD player or a set-top box 118. In contrast, in some implementations, the media devices disposed in the media environment 100 include a computer screen 120A that outputs the media content to the audience and a desktop computer 120B that streams the media content to the computer screen 120A. In some implementations, the media devices disposed in the media environment 100 includes a mobile device, e.g., a mobile phone 122, a tablet computer 124 and a laptop computer 126. Each of the media devices 118-126 includes one or more media player applications configured to receive and play media content items provided by the third-party content sources 106-110 or internal media source associated with the server system 104.

The server system 104 includes a unified media platform (UMP) 128 configured to manage media content recommendation and streaming to the one or more media devices in the media environment 100. The UMP 128 is configured to receive from the knowledge engine 130 a multi-dimensional unified user activity characteristic associated with a user account and program information of programs or content items provided by the media content sources 110, and generate the media content recommendations that are personalized for the user account. The unified user activity characteristic associated with the user account is obtained from a plurality of information sources 132, e.g., a search engine, a mapping application and an online retailer associated with the user account, each of which provides activity data related to the user account's activities via the respective software program or application. Optionally, the media content recommendations generated by the UMP 128 are presented on the network-connected television device 102 via a server-side television application 134, and the server-side television application 134 enables display of media content on the unified television application on the television device 102 in response to a user selection from the media content recommendations. Moreover, the UMP 128 may also function as a centralized media content management module configured to provide the media content recommendations to other media devices 118-126 in addition to the television device 102.

In some implementations, activity data associated with the user account is collected from the television application 134 and casting service module 136 (which are thereby part of the information sources 132), and returned to the knowledge graph engine 130 to update the unified user activity characteristic and media content recommendations associated with the user account.

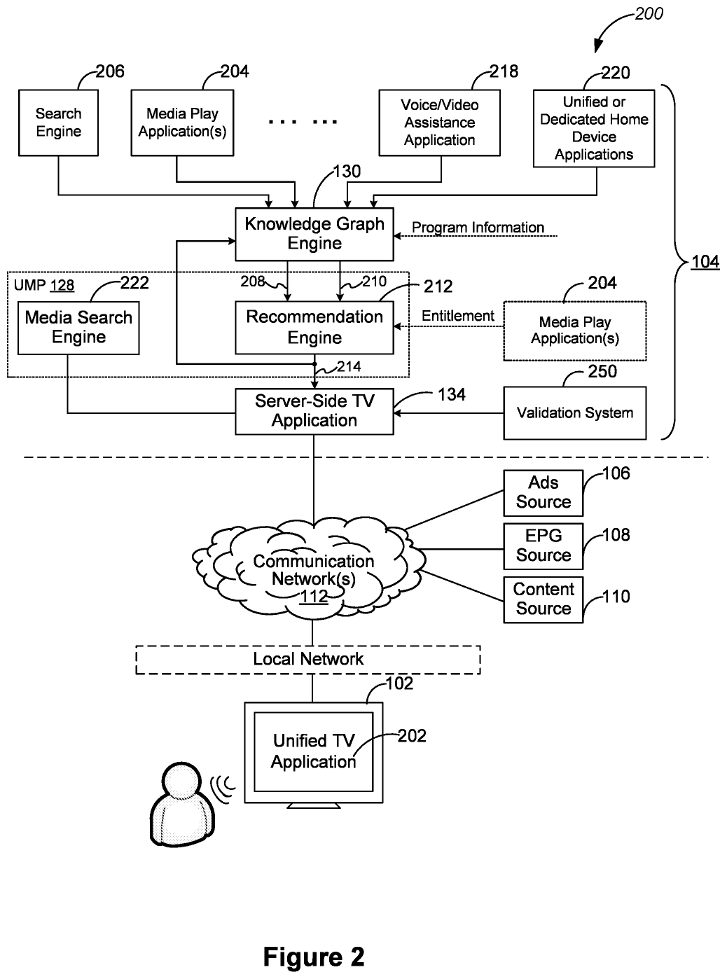

In some implementations, the UMP 128 also includes a media search engine (e.g., engine 222 in FIG. 2), which is configured to receive a search query from the server-side television application 134 or casting service module 136, and identify one or more media content items from the program information of programs or content items provided by the media content sources 110.

It is noted that a user account of the virtual user domain hosted by the server system 104 is also associated with one or more devices of other types, e.g., intelligent, multi-sensing, network-connected assistance devices 138 and home devices 140 that are installed in the media environment 100 associated with the user of the network-connected television device 102. Examples of the assistance devices 138 include a speaker assistance device 142 and a display assistance device 144. The speaker assistance device 142 is capable of collecting audio inputs, recognizing user commands from the audio inputs, and implementing operations (e.g., playing music, answering questions, etc.) in response to the user commands. The display assistance device 144 is capable of collecting audio and/or video inputs, recognizing user commands from the audio and/or video inputs, and implementing operations (e.g., playing music, presenting an image or video clip, answering questions, etc.) in response to the user commands. Examples of the home devices 140 include one or more of intelligent, multi-sensing, and network-connected: hazard detectors 146, camera systems 148, thermostats, entryway interface devices (e.g., smart doorbells and smart door locks), alarm systems, microphone devices, wall switches, wall plug interfaces, and appliances (e.g., refrigerators, stoves, ovens, televisions, washers, dryers, lights, stereos, intercom systems, garage-door openers, floor fans, ceiling fans, wall air conditioners, pool heaters, irrigation systems, security systems, space heaters, window AC units, and motorized duct vents).

Each of the assistance devices 138 and home devices 140 is optionally managed by a unified home device application or a dedicated user application, and linked to the user account in the virtual domain in conjunction with the unified television application of the network-connected television device. The activity data collected by the knowledge graph engine 130 may also include data collected by a subset of the assistance devices 138 and home devices 140, thereby allowing the media content recommendations provided to the user to reflect these activity data directly collected from a physical ambient associated with the media environment 100.

In some implementations, the server system 104 includes a device and application registry 150 configured for storing information of one or more user accounts managed by the server system 104 and information of user devices and applications associated with each of the one or more user accounts. For example, the device and application registry 150 stores information of the network-connected television device 102, remote control device 114, media devices 116-126, assistance devices 138 and home devices 140 and information of the corresponding unified television application, remote control application, media player applications, unified home device application, and dedicated user applications associated with the assistance devices 138 and home devices 140. Optionally, these media devices, assistance devices and home devices associated with the same user account are distributed across different geographical areas. Optionally, these devices are located at the same physical location. Each media, assistance or home device communicates with another device or the server system 104 using the one or more communication networks 112. The communication networks 112 used can be one or more networks having one or more type of topologies, including but not limited to the Internet, intranets, local area networks (LANs), cellular networks, Ethernet, Storage Area Networks (SANs), telephone networks, Bluetooth personal area networks (PAN) and the like. In some implementations, two or more devices in a sub-network are coupled via a wired connection, while at least some of devices in the same sub-network are coupled via a local radio communication network (e.g., ZigBee, Z-Wave, Insteon, Bluetooth, Wi-Fi and other radio communication networks).

FIG. 2 is an example operating environment 200 in which a server system 104 provides knowledge-based media content recommendations to a network-connected television device 102 in accordance with some implementations. In the example operating environment 200, the server system 104 includes a plurality of information sources 132, a knowledge graph engine 130, a UMP 128 and a server-side television application 134. The server system 104 hosts a virtual user domain including a user account associated with the server-side television application 134 and a unified television application 202 implemented at the network-connected television device 102. The user account is also associated with a plurality of media player applications 204 and a plurality of user applications, e.g., a search engine 206. The server system 104 stores activity data for each of the unified television application 202, media player applications 204 and user applications. The knowledge graph engine 130 of the server system 104 computes a multi-dimensional unified user activity characteristic 208 (e.g., concerning user preferences or affinities) from the stored activity data, and obtains program information associated with the plurality of media player applications 204, resulting in de-duplicated program information 210 for a plurality of unique programs (also called media content items). The UMP 128 includes a recommendation engine 212 that is configured to compare the user activity characteristic 208 to the program information 210 for the plurality of unique programs to identify an ordered subset of the unique programs 214 to recommend to a user via the unified television application 202.

In an example, the knowledge graph engine 130 receives a number of search queries concerning “Star Wars” from the search engine 206 and determines that a user associated with the user account is interested in “Star Wars.” The plurality of unique programs associated with the program information are ranked in view of the user's interests, preferences or affinities (i.e., represented by the unified user activity characteristic 208). A certain number of top-ranked unique programs are selected and categorized into clusters. Given the user's interest in “Star Wars” indicated by the search queries, the top-ranked unique programs include one or more media content items related to “Star Wars,” and the clusters include a cluster related to “Star Wars,” e.g., “Sci-Fi Movies like Star Wars.”

The ordered subset of the unique programs 214 identified by the recommendation engine 212 is represented by an ordered sequence of information items, and the ordered sequence of information items is provided to the server-side television application 134 and enabled for display via the unified television application 202 of the network-connected television device 102. In some situations, the activity data used by the knowledge graph engine 130 and the resulting unified user activity characteristic 208 are constantly changing. The ordered subset of the unique programs 214 may be identified dynamically. For example, the ordered subset of the unique programs 214 is updated periodically or in response to a request by the user of the network-connected television device 102. In some situations, each unique program in the ordered subset 214 has a lifetime that is determined based on a respective content type of the respective unique program, and has to be removed from the recommended ordered subsequent after the lifetime expires. In some implementations, the unified user activity characteristic 208 can vary by a time of day and a day of week, so is the ordered subset of the unique program 214 recommended via the unified television application 202.

The plurality of user applications acts as the plurality of information sources 132 to provide the activity data of a user of the television device 102, and includes at least an Internet search engine 206. The server system 104 stores and provides, to the knowledge graph engine 130, search queries and search results for a plurality of search operations implemented by the Internet search engine 206 from the user account. Additionally, in some implementations, the server system 104 stores watch information associated with the user account for a subset or all of the media player applications 204 and purchase information associated with the user account for a subset of the user applications (e.g., an online retailer application). Such watch information and purchase information are provided to the knowledge graph engine 130 in conjunction with the search queries and search results. In some implementations, the plurality of user applications includes a voice or video assistance application 218 associated with the speaker or display assistance device 142 or 144. In some implementations, the plurality of user applications includes a unified home device application and/or dedicated home device applications 220 associated with one or more home devices 140. Activity data collected by these assistance application 218 and home device applications 220 are also stored and provided to the knowledge graph engine 130.

Optionally, one of the media player applications 204 is provided by the server system 104 itself. Optionally, the media player applications 204 are provided by the third-party media content sources 110 distinct and/or remote from the server system 104. In an example, the virtual user domain is associated with a Google user account (e.g., abc@gmail.com). The media player applications 204 include YouTube which is provided by Google and other media player applications (e.g., Netflix, Amazon Prime, Hulu) which are not provided by Google and hosted independently of Google.

In some implementations, the program information associated with the plurality of media player applications 204 includes one or more of: schedule information, a short summary of plot, cast information, rating information, and commentary of current and scheduled programs that are or will be available on each of the media player applications. The program information is optionally provided to the server system 104 in a program catalog by each of the third-party media content sources 110 associated with the plurality of media player applications 204. Optionally, the program information is provided to the server system 104 by the EPG source 108. Alternatively, in some implementations, the program information associated with the plurality of media player applications 204 includes public media information downloaded from a public database that is independent of the user account. It is noted that the program information associated with a media player application may be provided to the server system 104 independently of whether the user account associated with the television device 102 and the unified television application 202 subscribes to the media player application and has an access right to media content provided via the media player application.

In some implementations, program information that is provided by different media content sources 110 concerning the same media content item is not identical and can vary to different levels, thereby requiring deduplication of the program information associated with the plurality of media player applications. Specifically, in some implementations, a first media content item is provided by a first media player application and is associated with first program information. A second media content item is provided by a second media player application and is associated with second program information in the second media player application. The second program information is distinct from the first program information. The knowledge graph engine 130 identifies a similarity level of the first and second program information and determines that the similarity level exceeds a similarity threshold. In accordance with the determination, the knowledge graph engine 130 de-duplicates and aggregates the first program information of the first media content item and the second program information of the second media content item, and determines that one of the plurality of unique programs is associated with both the first and second media content items. That said, the first and second media content items provided by two distinct media player applications correspond to the same unique program or media content item. Further, in some implementations, the knowledge graph engine 130 identifies the similarity level of the first and second program information by identifying a first keyword from the first program information and identifying a second keyword from the second program information. The first and second keywords are compared semantically to identify the similarity level of the first and second program information. For example, two program information items are generally consistent, but recite different keywords of “police” and “inspector” that are semantically close. These two program information items correspond to a relatively high similarity level that is higher than the similarity threshold.

In some implementations, in addition to deduplication, the program information associated with the plurality of media player applications is processed to compute a program characteristic for one of the unique programs. The multi-dimensional unified user activity characteristic is then compared to the computed program characteristic to result in a consistency score. The recommendation engine 212 is configured to determine whether the consistency score exceeds a consistency threshold, and identify the one of the unique programs to recommend to the user via the unified television application when the consistency score exceeds the consistency threshold. Alternatively, in some implementations, to identify each of the ordered subset of the unique programs, the recommendation engine 212 identifies one or more keywords based on the multi-dimensional unified user activity characteristic, and searches the one or more keywords in the de-duplicated program information of the plurality of unique programs to identify the respective unique program in the ordered subset of the unique programs.

In some implementations, the recommendation engine 212 receives entitlement information of a subset of the plurality of media player applications. For each of the ordered subset of the unique programs, the recommendation engine 212 determines that the respective unique program corresponds to a respective media player application to which the user of the network-connected television device has an access right based on the entitlement information. In accordance with the entitlement information, the user may have the access right of the respective unique program because the user has subscribed to the respective media player application or because the respective unique program is free to review with or without a sign-up. The respective unique program that is free to review includes media content freely available over the air, e.g., via a broadcasting service or IPTV delivered feeds and media content that is made available due to regional regulations or entitlement.

Stated another way, personal preferences shown by the multi-dimensional unified user activity characteristic are used to select a set of unique programs from the unique programs provided by the media content sources 110 and rank the selected set of unique programs. The selected set of unique programs is further filtered according to the entitlement information that indicates whether the user account is entitled to (e.g., has an access right to) media content provided by the media content sources 110 via the corresponding media player applications 204. This entitlement information associated with the media player applications is optionally entered by the user of the unified television application during an initial application personalization process or an execution stage of the unified television application 202. Optionally, this entitlement information associated with the media player applications is automatically extracted from the media player applications.

In some implementations, the UMP 128 also includes a media search engine 222 configured to receive a search query from the server-side television application 134 and identify one or more media content items from the program information 210 of programs or content items provided via the media player applications 204.

The server system 104 has one or more processors and memory storing instructions for execution by the one or more processors. In some implementations, the server system 104 includes a single server computer configured to implement functions of the knowledge graph engine 130, the recommendation engine 212, the media search engine 222 and the server-side television application 134. Alternatively, in some implementations, the server system 104 includes two or more separate server computers each of which is configured to implement functions of one or more of the knowledge graph engine 130, the recommendation engine 212, the media search engine 222 and the server-side television application 134.

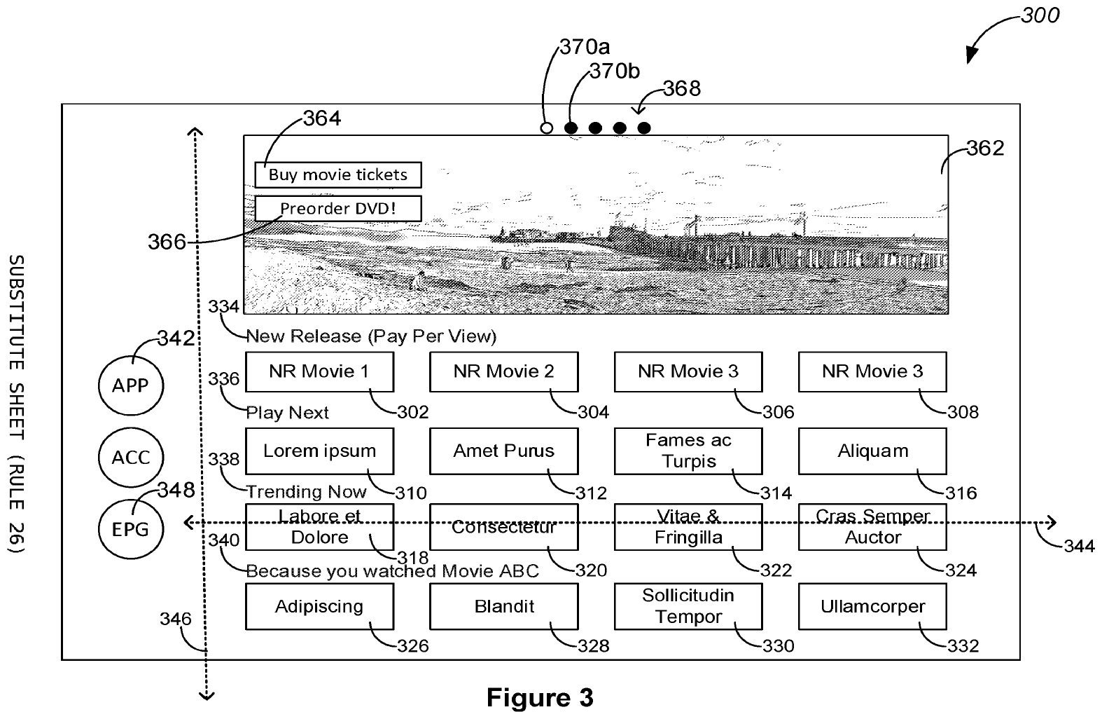

FIG. 3 is an example unified user interface 300 for display on a network-connected television device 102 in accordance with some implementations. A unified television application 202 is executed locally at the network-connected television device 102 to display the unified user interface 300. As explained above with reference to FIG. 2, the server system 104 identifies an ordered subset of the unique programs 214 based on the user activity characteristic 208 and the program information 210 for the plurality of unique programs. The unified television application 202 obtains from the server system 104 a media recommendation stream including an ordered sequence of selectable information items 302-332 that corresponds to the identified ordered subset of unique media content items or programs 214. For each selectable information item, the media recommendation stream includes a respective command to be executed in response to a user selection of the respective selectable information item displayed on the network-connected television device 102.

In some implementations, the corresponding ordered sequence of selectable information items is categorized into an ordered list of clusters 334-340. That said, a plurality of clusters 334-340 is created for display on the unified user interface 300, and physically arranged according to a predefined cluster order. Optionally, these clusters are dynamically created and arranged based on the multi-dimensional unified user activity characteristic 208. In some implementations, the clusters recommended via unified television application 202 has a certain heterogeneity level, i.e., has a number of different clusters that is larger than a predetermined number. For example, three or more different clusters have to be recommended via the unified television application 202. Alternatively, in some implementations, the clusters displayed on the unified user interface 300 have a similarity score that is controlled below an inter-cluster similarity threshold for a number of adjacent clusters. This is to avoid the situation where similar clusters and information items are arranged adjacent to each other in highly-related clusters. In some implementations, a benchmark is established to define the inter-cluster similarity threshold across the number of adjacent clusters.

Each cluster includes one or more information items in the ordered sequence that are ordered into an ordered sub-list of the information items in the respective cluster. For each cluster (e.g., a first cluster 338), the respective subset of the ordered sequence of selectable information items (e.g., information items 318-324) are physically arranged according to a predefined information item order that is determined based on the multi-dimensional unified user activity characteristic 208 of a user account associated with the ordered sequence of selectable information items.

Examples of the clusters shown on the unified user interface 300 include “New Release” 334, “Play Next” 336, “Trending Now” 338, “Because You Watched Movie ABC” 340, and “Action Movies.” In another example, a cluster is dedicated to a single media player application (e.g., YouTube), and the subset of information items associated with the cluster corresponds to a mixture of shows, movies and television content provided by the single media player application. Each of the clusters thereby corresponds to a respective ordered sub-list of information items and is defined according to one or more categories: content type (e.g., “Action Movies”), viewing history (e.g., “Because You watched Movie ABC”), release time (e.g., “Trending”), or content source (e.g., different streaming services and a broadcast television channel providing action movies). Particularly, the information items in the cluster of “New Release” are determined based on one or more of a content type/format, a content quality, a recency, a popularity, a seasonality, and an application lifecycle associated with media content items or programs corresponding to the information items in “New Release.”

In some implementations, media content items corresponding to the information items in the cluster of “New Release” or “Trending Now” are provided by transactional video-on-demand (TVOD) content providers, and a selection of a media content item in “New Release” or “Trending Now” is configured to enable a user interface prompted to the user of the television device 102 to collect payment for reviewing the media content item. Optionally, this cluster of “New Release” or “Trending Now” is provided as part of the ordered sequence of information items corresponding to the ordered subset of the unique programs 214 that is determined based on the unified user activity characteristic 208. Optionally, this cluster of “New Release” or “Trending Now” is provided to all user accounts as a supplement to the ordered sequence of information items corresponding to the ordered subset of the unique programs 214, independently of the unified user activity characteristic 208 of an individual user account.

In some implementations, media content items corresponding to the information items in the cluster of “Action Movies” are provided by subscription video-on-demand (SVOD) content providers. A selection of a media content item in this cluster is configured to enable a media content item page (also called a summary page) or initiate display of the media content item without soliciting instant payment. Further, in some implementations, a media content item corresponding to an information item in the cluster of “Play Next” is optionally provided by a SVOD or TVOD content provider. In response to a selection of a media content item in this cluster of “Play Next,” the television device 102 resumes displaying the media content item, allowing the user of the television device 102 to have a one-click access to continue watching a favorite show or movie.

For each cluster on the unified user interface 300, part or all of the ordered sub-list of information items is displayed depending on a total number of information items the respective sub-list has, a size of each information item, and an available display space associated with the respective cluster. In some implementations, each of the ordered subset of the unique programs 214 is distinct from any other unique programs of the ordered subset of the unique programs 214. Any two of the information items 302-332 displayed in the unified user interface 300 are distinct from each other. In some situations, any two of the information items 302-332 displayed in the same cluster of the unified user interface 300 are distinct from each other. Alternatively, in some situations, two of the information items 302-332 may be identical, but are recommended in different clusters, e.g., the information item 310 associated with “Downton Abbey” shows up in both a cluster of “Play Next” 336 and a cluster of “Drama.”

In some implementations, the unified user interface 300 includes an application affordance item 342 distinct from the ordered list of clusters and corresponding selectable information items displayed therewith. In response to a user action on the affordance item 342 (e.g., a selection of the item 342 via the remote control device 114), the unified television application 202 updated the unified user interface 300 with a page of information items each of which represents a respective media player application 204. In some implementation not shown in FIG. 3, the unified user interface 300 further includes an alternative cluster of information items each of which represents a respective one of the plurality of media player applications 204.

In some implementations, the unified user interface 300 includes an EPG affordance item 348. In response to a user action on the affordance item 348 (e.g., a selection of the item 348 via the remote control device 114), the unified television application 202 displays a unified EPG page that includes a timetable of a plurality of content items and programs that are provided by broadcasting services (e.g., television, cable, satellite, YouTube) and organized in a temporal order. The content items and programs are selected at least partially based on a location of the network-connected television device 102. In some implementations, the plurality of content items and programs are also determined by comparing the multi-dimensional unified user activity characteristic 208 and de-duplicated program information corresponding to media content items and programs provided by the broadcasting services.

The information items 302-332 are provided by more than one media content source 110, but are organized and displayed on the unified user interface 300 based on content (not media content sources) of the media content items or programs 214 recommended by the recommendation engine 212 of the server system 104. Specifically, each cluster displayed on the unified user interface 300 includes a subset of the ordered sequence of selectable information items. A first cluster 338 includes a first selectable information item 318 and a second selectable information item 320. The first and second selectable information items 318 and 320 of the first cluster 338 are concurrently displayed on the unified user interface 300. In response to a first user selection of the first selectable information item 318, the television device 102 displays information of a first media content item provided by a first content provider. In response to a second user selection of the second selectable information item 320, the television device 102 displays information of a second media content item provided by a second content provider. The second content provider is distinct from the first content provider although information of the first and second content providers is optionally hidden on the unified user interface 300 which shows the clusters 334-340 and the selectable information items 302-332.

In some implementations, each of the first and second content providers is selected from a broadcasting television service, a broadcasting satellite service, a cable service, a subscription video-on-demand (SVOD) content provider, a transactional video-on-demand (TVOD) content provider, an ad-based video-on-demand (AVOD) service, and a replay and time-shifted content playback source. Optionally, the first or second content provider relies on a tuner-based delivery of over-the-air media content. Optionally, the first or second content provider delivers live television streams based on Internet Protocol televisions (IPTV) or other Internet-delivered linear, live or synthetic-live content sources, and the first or second content provider is an Internet-based live streaming service. If one of the information item 302-332 corresponds to a broadcasting television service (e.g., NBC, ABC, ESPN), a unique broadcast program corresponding to the one of the information item 302-332 is permitted to be shown at a location of the television device 102 in compliance with a geographical limitation associated with the broadcasting television service.

It is noted that the unified television application 202 is associated with a user account of a virtual user domain hosted by the server system 104. In some implementations, the first content provider is associated with a first media player application, and the first media player application is optionally associated with the user account of the virtual user domain hosted by the server system 104. In some implementations, the second content provider is associated with a second media player application, and the second media player application is optionally associated with the user account of the virtual user domain hosted by the server system 104.

In some situations, the first cluster 338 has more selectable information items than a number of slots on a corresponding space of the unified user interface 300 allocated to the first cluster 338. The subset of selectable information items corresponding to the first cluster 338 is physically arranged and configured to move along a first axis 344 of the unified user interface 300, such that different information items in the subset of selectable information items corresponding to the first cluster 338 can be displayed on the unified user interface 300 and recommended to the user of the television device 102. Specifically, a first user action on the information item 318 (e.g., a user press on a “Previous” button on the remote control device 114) can enable the information items 318-322 to shift right by one slot to cause the information item 324 to exit the unified user interface 300 and a new information item associated with the first cluster 338 to enter the unified user interface 300. Likewise, a second user action on the information item 324 (e.g., a user press on a “Next” button on the remote control device 114) can enable the information items 320-324 to shift left by one slot to cause the information item 318 to exit the unified user interface 300 and another new information item associated with the first cluster 338 to enter the unified user interface 300. When one of the first and second user actions is continuously applied, a start or end information item in the first cluster 338 is displayed. When this happens, the one of the first and second user actions optionally does not change the information items displayed on the unified user interface 300 or continues to display the end or the start of the subset of selectable information items in the first cluster 338 as the new information item following the start or end information item, respectively.

Further, in some implementations, a plurality of clusters are distributed along a second axis 346 of the unified user interface 300, and includes a first subset of clusters and a second subset of clusters. The first subset of clusters may be moved out of the unified user interface, and the second subset of clusters may be moved into the unified user interface along the second axis. For example, the first subset of clusters includes the cluster 334. A third user action (e.g., a user press on an “Up” button on the remote control device 114) on one of the information items 302-308 can enable the clusters 334-338 to shift down by one slot to cause the cluster 340 to exit the unified user interface 300 and a new cluster preceding the cluster 334 to enter the unified user interface 300 from a top edge. Likewise, a fourth user action (e.g., a user press on a “Down” button on the remote control device 114) on one of the information items 326-332 can enable the clusters 336-340 to shift up by one slot to cause the cluster 334 to exit the unified user interface 300 and another new cluster following the cluster 340 to enter the unified user interface 300. When one of the third and fourth user actions is continuously applied, a top or bottom cluster of the plurality clusters is displayed. When this happens, the one of the third and fourth user actions optionally does not change the clusters displayed on the unified user interface 300 or continues to display the bottom or top cluster of the plurality of clusters as the new cluster following the top or bottom cluster, respectively.

In some implementations, referring back to FIG. 2, each of the media play applications 204 can be provided by a content partner for validation and/or approval by the server system 104, which can include a validation system 250. For example, a content partner or other third-party media content source can provide a media application and associated files for use with the unified television application 202. Upon approval by the validation system 250 and/or the server system 104, a media play application 204 can be available for installation on the network-connected television system, where one or more unified user interfaces 300 can be presented with media actions in the unified television application 202.

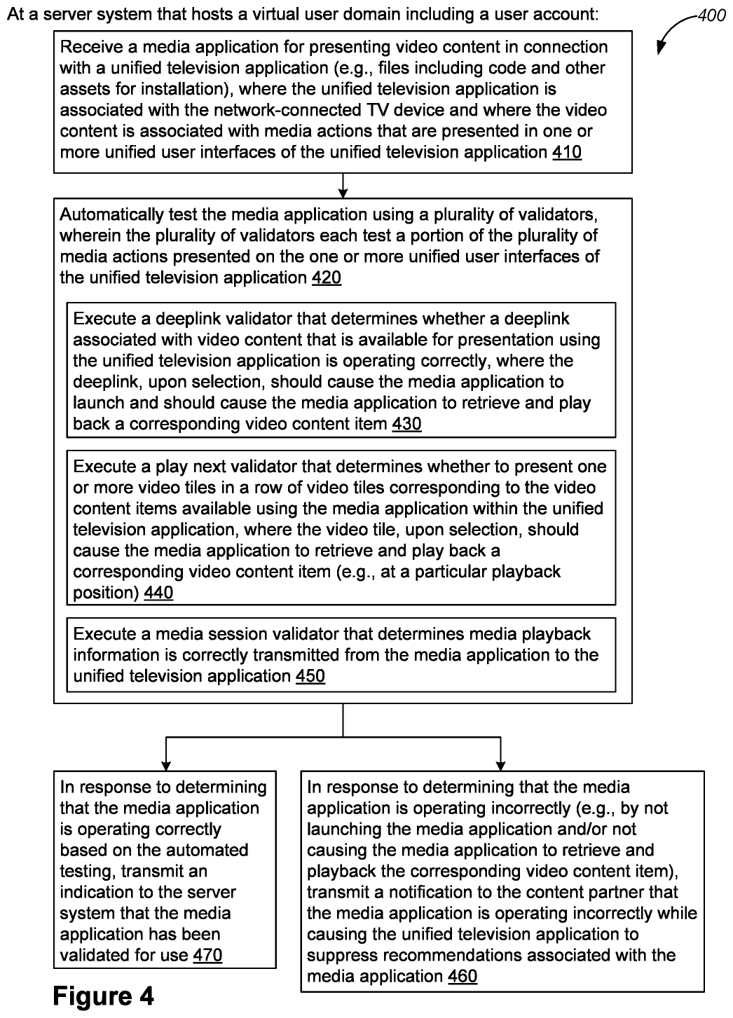

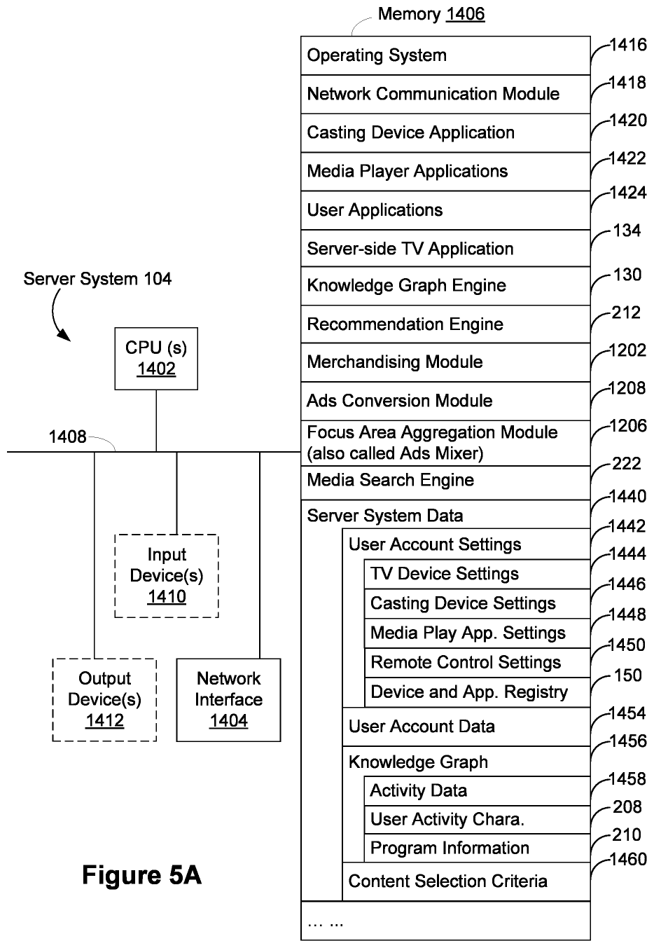

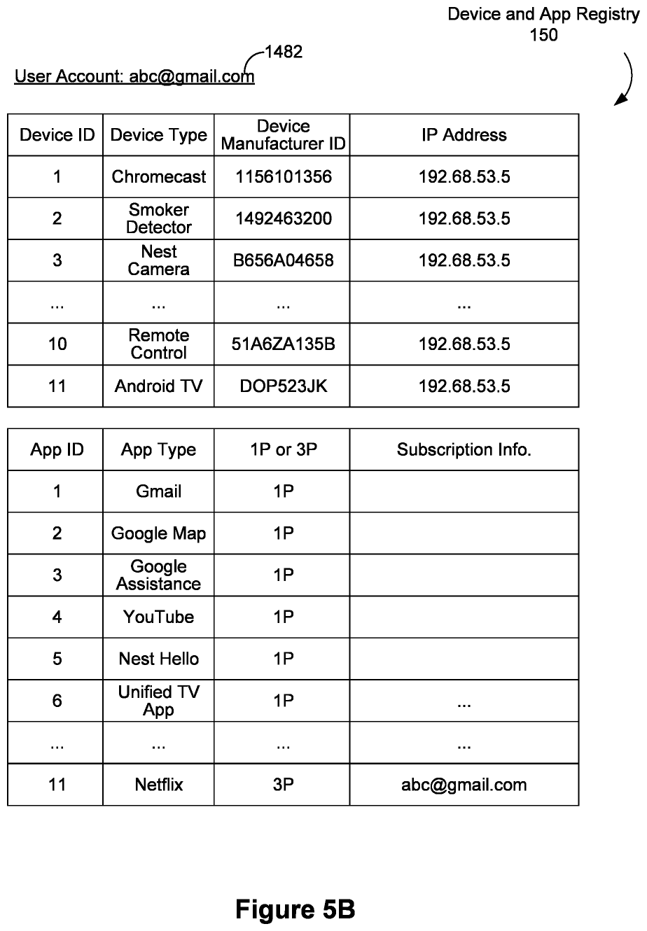

FIG. 4 is an example flow chart of a method 400 of automated media application validation of a media application for use with a unified television application on a network-connected television device 102 in accordance with some implementations of the disclosed subject matter. Method 400 can be performed by a server system 104 and can, optionally, be governed by instructions that are stored in a non-transitory computer readable storage medium and that are executed by one or more processors of the server system 104. Each of the operations shown in FIG. 4 may correspond to instructions stored in a computer memory or non-transitory computer readable storage medium (e.g., a memory 1406 of the server system 104 in FIG. 5A). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in the method 400 may be combined and/or the order of some operations may be changed.

The server system 104 can receive a media application for use with a unified television application executing on a network-connected television device 102 at 410. When the media application is installed on the network-connected television device 102, the media application can be used to present video content in connection with the unified television application executed on the network-connected television device 102.

In some implementations, the server system 104 can receive the media application in any suitable form, such as source code, assembly language code, object code, or other instruction format that is interpreted by one or more processors. Additionally or alternatively, the server system 104 can receive a URL or any other suitable link to obtain the files associated with the media application for potential incorporation with the unified television application.

In some implementations, the server system 104 can transmit the media application and any suitable information corresponding to the media application to a validation system 250 for automated media validation at 420. The validation system 250 can include multiple validators, where each validator can test the media integration of a media application provided by a content partner. For example, each validator can test a subset of media actions presented on one or more unified user interfaces of a unified television application executing on the network-connected television device 102. The validation system 250 and its multiple validators can, for example, perform an automated validation of the media application prior to transmitting the media application to an entity that manages the server system 104 and that makes the media application available for installation on a network-connected television device 102. This can also, for example, provide consistent unified user interfaces across different media applications on a unified television application executing on a network-connected television device 102 (e.g., by periodically testing the media application using the multiple validators). This can further, for example, minimize human intervention in validating the media application, thereby decreasing the amount of time needed to release a media application such that the media application is made available for installation on a network-connected television device 102.

At 430, the validation system 250 can include a deeplink validator that determines whether a deeplink associated with video content that is available for presentation using the media application is operating correctly. Such a deeplink being presented on a unified user interface of a unified television application, upon selection, can cause the media application to launch and can cause the media application to retrieve and playback the corresponding video content item. For example, as shown in FIG. 3, a deeplink associated with information item 326 can, upon being selected by a user of the unified television application, cause a corresponding media application to launch and cause the corresponding media application to retrieve and playback the corresponding video content item (e.g., the content item entitled “Adipiscing”). In a more particular example, the deeplink validator can determine that the deeplink associated with information item 326, upon being selected, causes a corresponding media application to launch and causes the corresponding media application to retrieve and playback the corresponding video content item (e.g., the content item entitled “Adipiscing”) in which the audio playback is detected and, upon returning to the unified television application (e.g., a home screen), the audio playback is no longer detected. In another example, as shown in FIG. 3, the deeplink validator can determine each deeplink that would be provided by the media application in the unified television application, such as information items 326-332 in user interface 300. In yet another example, the deeplink validator can select a subset of deeplinks that would be provided by the media application in the unified television application (e.g., random selection, one deeplink from each user interface, one deeplink from each row of video tiles, one deeplink for each type of content recommendation, etc.).

In continuing this example, the deeplink validator can determine whether selection of one or more of the deeplinks causes the media application to launch and causes the media application to retrieve and playback the corresponding video content item. In response to determining that a deeplink is operating incorrectly by not launching the media application and/or not causing the media application to retrieve and playback the corresponding video content item, the validation system can generate a notification to the content partner that provided by the media application for use with the unified television application, where the notification indicates that one or more deeplinks in the unified television application are operating incorrectly. Such a notification can include, for example, one or more error codes that resulted from the automated testing using the first validator, a detailed description of issues in the media integration of the media application with the unified television application, a screenshot of the unified user interface in which the incorrectly operating deeplink appears, etc.). In some implementations, the notification can include an indication of the remaining deeplinks that are operating correctly. In a more particular example, the generated notification can include a report of each tested deeplink that includes a deeplink (https://watch.mediaapp.com/1/network/ABC123/watch), an indication on whether the deeplink passed or failed the deeplink validation test (e.g., “PASS” or “FAIL”), and/or an error code indicating why the deeplink failed the deeplink validation test (e.g., “FAIL, NO_AUDIO,” “FAIL, INVALID_URL,” “PASS, NO_ERROR,” etc.).

Additionally or alternatively, the validation system 250 can provide suggestions to the content partner on how to address the deeplink issues inhibiting the media application from being validated or otherwise approved for use with the unified television application (e.g., based on error codes issued by the deeplink validator). For example, in response to detecting that audio playback for a video content item associated with a particular deeplink continues to be played back when returning to the home screen of the unified television application, the validation system 250 can direct the content partner to the portion of code that handles audio playback for that deeplink.

In instances in which the media application has been installed on the network-connected television device or is otherwise available for use by the unified television application, the validation system 250 can cause the unified television application to suppress content recommendations and other suitable notifications that include the deeplink from being presented by the unified television application. For example, referring back to FIG. 3, the unified television application can be configured to remove the cluster 340 entitled “Because You watched Movie ABC” as each of the corresponding video content items is associated with the media application having deeplinks that are not operating correctly (e.g., failed the test performed by the deeplink validator).

Referring back to FIG. 4, at 440, the validation system 250 can include a play next validator that determines whether to present one or more video tiles in a row of video tiles corresponding to the video content items available using the media application within the unified television application for a user having a user account that is authenticated with the unified television application to consume the corresponding video content at a later time. For example, in some implementations, a media content item corresponding to an information item in the cluster of “Play Next” is optionally provided by a content provider. In response to a selection of a media content item in this cluster of “Play Next,” the network-connected television device 102 resumes displaying the media content item, thereby allowing the user of the network-connected television device 102 to have a one-click access to continue watching a favorite show or movie. For example, as shown in FIG. 3, a “Play Next” cluster 336 can be provided in the unified user interface 300 of the unified television application. The one or more information items in the “Play Next” cluster 336 can correspond to a video content item that the user has indicated as being of interest, can correspond to a video content item that is related to content that the user has consumed, etc.

The play next validator can perform a number of tests associated with the information items in the “Play Next” cluster 336 that are associated with the media application. For example, the play next validator can determine whether the deeplink that is associated with an information item in the “Play Next” cluster and that is associated with the media application plays the correct media content upon being selected. In another example, the play next validator can determine whether an information item is added to the “Play Next” cluster after watching a media content item for a particular period of time in which the media content item was not watched to completion (e.g., after one minute of playback). In continuing this example, the play next validator can determine whether the information item or play next entry in the “Play Next” cluster has been removed upon playing back the media content item to completion and/or can determine whether the information item or play next entry in the “Play Next” cluster for a subsequent media content item (e.g., the next episode) has been added. In some implementations, the play next validator can determine playback position correctness by determining whether the selection of the information item or play next entry in the “Play Next” cluster causes the media application to resume playback of the media content item from the last known playback position. In a further example, the play next validator can determine the latency or the amount of time for the media application to add the information item or play next entry in the “Play Next” cluster.

In continuing this example, the play next validator can determine whether the media application functions correctly with the “Play Next” cluster on the unified user interface of the unified television application. In response to conducting the one or more tests associated with the play next validator, the validation system 250 can generate a notification to the content partner that provided by the media application for use with the unified television application, where the notification indicates whether the media application is functioning correctly with the “Play Next” cluster. Such a notification can include, for example, one or more outcomes that resulted from the automated testing using the play next validator, a detailed description of issues in the media integration of the media application with the unified television application, etc.). In a more particular example, the generated notification can include a report of the outcomes of each test performed by the play next validator—e.g., a pass or fail outcome for the deeplink playback test, a pass or fail outcome for the play next entry removal, a pass or fail outcome for the last known playback position (e.g., for a media content item that was not watched to completion), a pass or fail outcome for the next episode update for episodic content (e.g., for an episodic media content item that was watched to completion in which a subsequent episode is available), a pass or fail outcome for the latency test that determines the amount of time to add a play next entry to the “Play Next” cluster, etc.

Additionally or alternatively, the validation system 250 can provide suggestions to the content partner on how to address the play next issues inhibiting the media application from being validated or otherwise approved for use with the unified television application (e.g., based on outcomes provided by the play next validator in which the media application failed). For example, in response to the play next validator detecting that the next episode of an episodic media content item was not added to the “Play Next” cluster upon completion of a current episode, the validation system 250 can direct the content partner to the portion of code that handles episodic content and/or content recommendations for episodic content.

In instances in which the media application has been installed on the network-connected television device or is otherwise available for use by the unified television application, the validation system 250 can cause the unified television application to suppress content recommendations and other suitable notifications that include media content items available through the media application from being presented by the unified television application. For example, referring back to FIG. 3, the unified television application can be configured to remove the media content items associated with the media application from the “Play Next” cluster 336 as the media application is determined from the play next validator to not be operating correctly (e.g., failed the one or more tests performed by the play next validator).

Referring back to FIG. 4, at 450, the validation system 250 can include a media session validator that determines whether the media application transmits an indication of media playback to the unified television application. For example, the media session validator can determine, for a media playback session in which a user having an authenticated user account is consuming media content via the unified television application on the network-connected television device, whether the media application transmits indications of media playback to the unified television application. Such indications can include, for example, a content identifier, a source identifier, a playback position, a start time, content metadata, etc. It should be noted that the media session validator can include individual tests that determine whether each type of media session information is properly transmitted from the media application to the unified television application.

In response to determining that the media application is operating incorrectly by not transmitting media playback indications to the unified television application, the validation system 250 can transmit a notification to the content partner that provided by the media application for use with the unified television application, where the notification indicates that media application is not correctly passing media playback information to the unified television application.

In instances in which the media application has been installed on the network-connected television device or is otherwise available for use by the unified television application, the validation system 250 can cause the unified television application to suppress content recommendations and other suitable notifications provided by the media application from being presented by the unified television application (e.g., exclude the row of video tiles that is associated with a content source or a content partner from being presented on the unified user interface of the unified television application). For example, referring back to FIG. 3, the unified television application can be configured to remove the cluster 340 entitled “Because You watched Movie ABC” as each of the corresponding video content items is associated with the media application that is not operating correctly (e.g., failed the test performed by the media session validator) and configured to remove the media content items associated with the media application from the “Play Next” cluster 336 as the media application is determined from the play next validator to not be operating correctly (e.g., failed the one or more tests performed by the play next validator).

It should be noted that, although the implementation described herein includes three validators (e.g., the deeplink validator 430, the play next validator 440, and the media session validator 450), the validation system 250 can include any suitable number of validators.

It should be noted that the multiple validators of the validation system 250 can test the media application at any suitable time, such as prior to allowing the media application to be made available for installation and use on a network-connected television device or at predetermined time periods to ensure that the media integration of the media application continues to operate correctly (e.g., given the changing state of a unified television application that executes on the network-connected television device and that operates in connection with the media application).

It should be noted that the validation system can update the one or more validators at any suitable time. For example, in some implementations, additional validators for automatically testing media applications and the media actions corresponding to the media applications in the unified television application can be added—e.g., a validator that determines whether caption information is being correctly presented by the media application based on location information associated with the network-connected television device. In another example, in some implementations, an updated validator for automatically testing media applications and the media actions corresponding to the media applications in the unified television application can replace one of the validators in the validation system, such as an updated deeplink validator.

In some implementations, the validation system 250 can batch and/or schedule the tests of each of the validators on one or more network-connected television devices. For example, the validation system 250 can schedule particular deeplink tests and/or particular play next tests on network-connection television devices at particular dates (e.g., every six months), at particular times (e.g., at times that the network-connected television device is unlikely to be used by the user), etc. In another example, the validation system 250 can aggregate the results from the tests of each of the validators for providing a notification or report to the content partner.

Referring back to FIG. 4, in response to the automated testing of the media application using one or more of the validators determining that an issue or error exists that inhibits the validation of the media application, the validation system 250 can transmit notifications to the content partner concerning the issue and/or error that inhibits the validation of the media application at 460 (e.g., prior to transmitting the media application for validation and approval by a server system that manages the unified television application or any other suitable platform that allows the installation of media applications on the network-connected television device).

Alternatively, in response to the automated testing of the media application using one or more of the validators determining that no issues or errors exist that inhibit the validation of the media application, the media application or a validation approval of the media application can be transmitted to a server system that manages a unified television application at 470, where the media application can then be made available for installation and use on the network-connected television device. For example, the validation system 250 can transmit an indication to an entity that manages the unified television application that the media application has been validated by the one or more validators of the validation system 250.

It should be understood that the particular order in which the operations in FIG. 4 have been described are merely exemplary and are not intended to indicate that the described order is the only order in which the operations could be performed. One of ordinary skill in the art would recognize various ways to display information items and focus content in a unified user interface as described herein.

FIG. 5A is a block diagram illustrating a server system 104 of a media environment in accordance with some implementations. The server system 104, typically, includes one or more processing units (CPUs) 1402, one or more network interfaces 1404, memory 1406, and one or more communication buses 1408 for interconnecting these components (sometimes called a chipset). The server system 104 could include one or more input devices 1410 that facilitate user input, such as a keyboard, a mouse, a voice-command input unit or microphone, a touch screen display, a touch-sensitive input pad, a gesture capturing camera, or other input buttons or controls. Furthermore, the server system 104 could use a microphone and voice recognition or a camera and gesture recognition to supplement or replace the keyboard. In some implementations, the server system 104 includes one or more cameras, scanners, or photo sensor units for capturing images, for example, of graphic series codes printed on the electronic devices. The server system 104 could also include one or more output devices 1412 that enable presentation of user interfaces and display content, including one or more speakers and/or one or more visual displays.

Memory 1406 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 1406, optionally, includes one or more storage devices remotely located from one or more processing units 1402. Memory 1406, or alternatively the non-volatile memory within memory 1406, includes a non-transitory computer readable storage medium. In some implementations, memory 1406, or the non-transitory computer readable storage medium of memory 1406, stores the following programs, modules, and data structures, or a subset or superset thereof:
Operating system 1416 including procedures for handling various basic system services and for performing hardware dependent tasks;
Network communication module 1418 for connecting the server system 104 to other devices (e.g., various servers in the server system 104, ads sources 106, EPG source 108, media content sources 110, network-connected television device 102, remote control devices 114, media devices 114-126, assistance devices 138, home devices 140, and mobile devices) via one or more network interfaces 1404 (wired or wireless) and one or more networks 112, such as the Internet, other wide area networks, local area networks, metropolitan area networks, and so on;
Casting device application 1420 that is executed to provide server-side functionalities for device provisioning, device control, and user account management associated with casting device(s) 118;
One or more internal media player applications 1422 (e.g., YouTube and Google Play) that are executed to provide server-side functionalities for media display and user account management;
One or more user applications 1424 including one or more of an Internet search engine, a mapping application, a social media application, a retailer application, and a device application that is executed to provide server-side functionalities for device provisioning, device control, data processing and data review of a corresponding assistance device 138 or home device 140; and
Server-side television application 134 executed to provide server-side functionalities for device provisioning, device control, data processing and data review of the network-connected television device 102;
Knowledge graph engine 130 that is executed to collect activity data from media player applications and user applications associated with a user account, compute a multi-dimensional unified user activity characteristic 208 based on the collected activity data, and collect program information (de-duplicated or not) associated with the media player applications 204;
Recommendation engine 212 that is executed to compare the user activity characteristic 208 to the program information 210 for a plurality of unique programs to identify an ordered subset of the unique programs 214 to recommend to a user via the unified television application 202;
Merchandising module 1202 executed to provide focus items selected to promote media content independently of the user activity characteristic 208 of an individual user account;
An ads management module 1208 executed to manage advertisement content provided by an internal ads provider 1204 or an external ads source 106, including an ads conversion module that is executed to customize media content items received from an external ads source 106 for display in the focus area 362 of the unified user interface 3000, e.g., according to a customized VAST format;
Mixer 1206 (also called a focus item aggregation module) that is executed to mix a plurality of focus items provided by two or more content sources (e.g., the recommendation engine 212, the merchandising module 1202, and ads providers 1204 or 106) sequentially according to a temporal order; and
Media search engine 222 that is executed to receive a search query from the server-side television application 134 or casting service module 136 and identify one or more media content items from the program information of programs or content items provided by the media content sources 110; and
Server system data 1440 storing at least data associated with control of media display on the network-connected television device 102, including:
User account settings 1442 for storing account settings of one or more user accounts and settings of devices and applications that are associated with each of the user accounts and managed by the server system 104, further including:
Television device settings 1444 for storing information associated with the television device 102, including common device settings (e.g., service tier, device model, storage capacity, processing capabilities, communication capabilities, etc.), and information associated with a corresponding unified television application 202 (including one or more of account access information, user preferences of media content types, and viewing history data);
Casting device settings 1446 for storing information associated with a casting device 118 and user accounts of the casting device application 1420, including one or more of account access information, information for device settings (e.g., service tier, device model, storage capacity, processing capabilities, communication capabilities, etc.);
Media player application settings 1448 for storing information associated with user accounts of one or more media player applications 204, including one or more of account access information, user preferences of media content types, and viewing history data;
Remote control settings 1450 for storing information associated with one or more remote control devices 114, e.g., common device settings (e.g., service tier, device model, storage capacity, processing capabilities, communication capabilities, etc.), media control functions linked to individual buttons, and commands and data for implementing each of the media content functions; and
Device and application registry 150 for storing information of one or more user accounts managed by the server system 104 and information of user devices and applications associated with each of the one or more user accounts;
User account data 1454 for storing data that are generated by various applications of a plurality of devices associated with each of the user accounts managed by the server system 104, e.g., display information associated with media content currently displayed on the television device 102;
Knowledge graph data 1456 associated with a knowledge graph engine 130 implemented by the server system 104, including one or more of: activity data 1458 of the unified television application 202, media player applications 204, and user applications 1424; a multi-dimensional unified user activity characteristic 208 derived from the activity data; and program information 210 associated with the plurality of media player applications 204; and
One or more content selection criteria 1460 applied by the unified television application 202 to control media content displayed on the television device 102.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 1406, optionally, stores a subset of the modules and data structures identified above. Furthermore, memory 1406, optionally, stores additional modules and data structures not described above.

FIG. 5B is an example device and application registry 150 of a server system 104 that stores information of one or more user accounts managed by the server system 104 and information of user devices and applications associated with each of the one or more user accounts in accordance with some implementations. In this example, a user account 1482 is defined according to an email address (e.g., abc@gmail.com) and associated with a plurality of user devices including casting devices 118 (e.g., Google Chromecast), a surveillance camera 148 (e.g., Nest Camera) and a remote control device 114. The device and application registry 150 stores one or more of a device identification (ID), a device type, a device manufacturer ID and an Internet protocol (IP) address for each user device associated with the user account. The device IDs are assigned to the user devices when the user devices are linked to the user account 1482. The manufacturer IDs include product serial numbers provided by manufacturers to identify the user devices uniquely. When each user device is being linked to the user account 1482, the respective manufacturer ID is requested for the purposes of authenticating the respective user device. The IP addresses of the user devices are applied to track the location of the user devices on the Internet. They are acquired during the course of linking the user devices to the user account 1482, and updated when locations of the user devices are changed in the Internet.

In some implementations, a first user device associated with the user account 1482 is linked to a second user device associated with the user account 1482. For example, the remote control device 114 (Device ID=10) is linked to the network-connected television device 102 (Device ID=11), but not to the casting device 118 (Device ID=1). In some implementations, the user account 1482 includes two or more remote control devices 114, each of the remote control devices 114 is uniquely linked to a specific network-connected television device 102 or casting device 118. In some implementations, the user account 1482 includes one remote control device 114 that are linked to more than one casting or television device according to a predetermined linking rule (e.g., according to a distance of the remote control device 114 to any one of the more than one casting or television device).

In some implementations, the user account 1482 defined according to the email address (e.g., abc@gmail.com) is also associated with the unified television application 202, a plurality of media player applications 204 and a plurality of user applications 1424. Each of the media player applications 204 is configured to display media content items or programs provided by a broadcasting service (television, satellite or cable) and a VOD content provider. The VOD content provider is optionally the server system 104 or a third-party content provider distinct from the server system 104. Examples of the media player applications 204 include, but are not limited to, YouTube, Google Play, Netflix, Hulu, Amazon Prime, HBO, and some television channel applications (e.g., ESPN, NBC, ABC and PBS). Conversely, examples of the plurality of user applications 1424 include an email application (e.g., Google Gmail), a map application (e.g., Google Map), an assistance application (e.g., Google Assistance), a home device application (e.g., Nest Camera, Nest Hello), and an online retailer application (e.g., Google Shopping). Optionally, each media player or user application is stored with one or more of: an application identification (ID), an application type, a flag indicating whether this is a first-part or third-party application, and entitlement/subscription information (e.g., membership type, credentials).

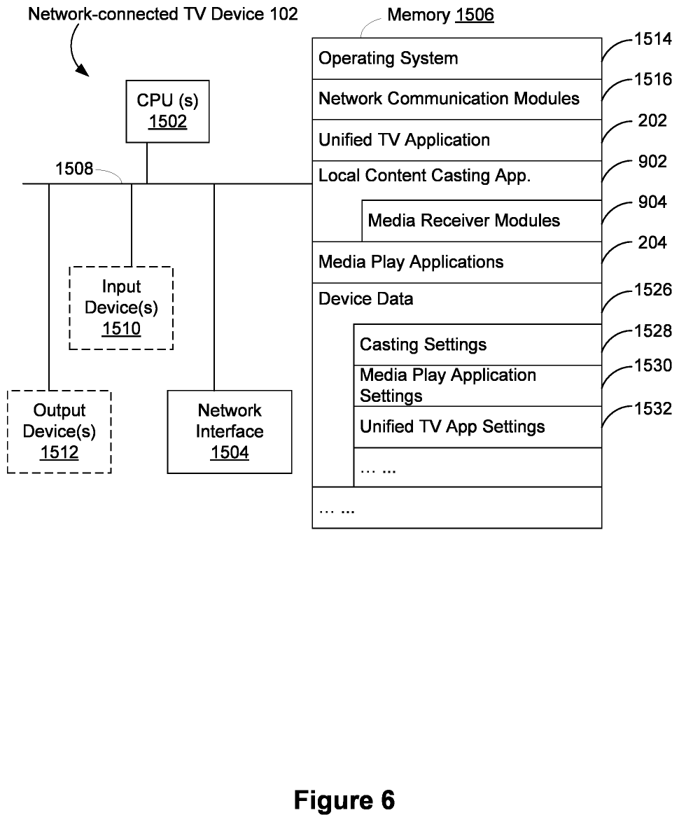

FIG. 6 is a block diagram illustrating an example network-connected television device 102 configured to display a unified user interface and media content provided by media player applications 204 in accordance with some implementations. The network-connected television device 102, typically, includes one or more processing units (CPUs) 1502, one or more network interfaces 1504, memory 1506, and one or more communication buses 1508 for interconnecting these components (sometimes called a chipset). Memory 1506 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 1506, optionally, includes one or more storage devices remotely located from one or more processing units 1502. Memory 1506, or alternatively the non-volatile memory within memory 1506, includes a non-transitory computer readable storage medium. The television device 102 could include one or more input devices 1510 that facilitate user input, such as input buttons or controls. Furthermore, the television device 102 could use a microphone and voice recognition or a camera and gesture recognition to supplement or replace the buttons. The television device 102 could also include one or more output devices 1512 that enable presentation of user interfaces and display content, including a speaker and/or a visual display.

In some implementations, memory 1506, or the non-transitory computer readable storage medium of memory 1506, stores the following programs, modules, and data structures, or a subset or superset thereof:
Operating system 1514 including procedures for handling various basic system services and for performing hardware dependent tasks;
Network communication module 1516 for connecting the network-connected television device 102 to other computers or systems (e.g., the server system 104, media content sources 110, remote control devices 114) via one or more network interfaces 1504 (wired or wireless) and one or more networks 112, such as the Internet, other wide area networks, local area networks, metropolitan area networks, cable television systems, satellite television systems, IPTV systems, and so on;
Unified television application 202 for presenting a unified user interface 300 with recommended media content and playing media content provided by media content sources 204 in response to a user selection of the recommended media content;
Local content casting application 902 configured to be called by the unified television application 202 in a restricted mode for playing media content items selected according to a content selection criterion, including a plurality of media receiver modules 904 each of which corresponds to a respective media content source 110 and is called to bypass a corresponding media player application 204 and play the media content items provided by the respective media content source;
Media player applications 204 that is executed to provide device-side functionalities for media display and user account management associated with corresponding media content sources 110; and
Device data 1526 storing at least data associated with control of media display on the television device 102, including:
Casting settings 1528 for storing information associated with user accounts of a casting device application, including one or more of account access information, information for device settings (e.g., service tier, device model, storage capacity, processing capabilities, communication capabilities, etc.), and information for automatic media display control;
Media player application settings 1530 for storing information associated with user accounts of the media player applications 204, including one or more of account access information, user preferences of media content types, and viewing history data; and
Unified television application setting 1532 for storing information associated with user accounts of the unified television application 202, including one or more of account access information, user preferences of media content types, and viewing history data associated with the unified television application 202.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 1506, optionally, stores a subset of the modules and data structures identified above. Furthermore, memory 1506, optionally, stores additional modules and data structures not described above.

It will also be understood that, although the terms first, second, etc. are, in some instances, used herein to describe various elements, these elements should not be limited by these terms. These terms are only used to distinguish one element from another. For example, a first type of audio feature can be termed a second type of audio feature, and, similarly, a second type of audio feature can be termed a first type of audio feature, without departing from the scope of the various described implementations. The first type of audio feature and the second type of audio feature are both types of audio features, but they are not the same type of audio feature.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

The foregoing description, for the purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method for media application validation, the method comprising:
receiving, at a server device having a hardware processor, a media application for presenting video content, the media application being associated with a content partner and the video content being associated with a plurality of media actions that are presented in at least one unified user interface of a unified television application executing on a network-connected television device;
testing, at the server device, the media application using a plurality of validators, the plurality of validators configured to test a portion of the plurality of media actions, the plurality of validators including a validator that determines whether a deeplink associated with the video content that is available for presentation using the network-connected television device is operating correctly, and the deeplink, upon selection, causing causes-the media application to launch and cause the media application to retrieve and play back a corresponding video content item;
determining, using the validator, a plurality of deeplinks that are associated with the video content that is available for presentation using the media application, the plurality of deeplinks being presented on the at least one unified user interface; and
determining, using the validator, whether selection of the plurality of deeplinks causes the media application to launch and cause the media application to retrieve and play back the corresponding video content item.

2. The method of claim 1, further comprising:
in response to determining that a subset of the plurality of deeplinks are operating incorrectly by not launching the media application and not causing the media application to retrieve and playback the corresponding video content item, transmitting, at the server device, a notification to the content partner that the subset of the plurality of deeplinks is operating incorrectly while causing the unified television application to suppress recommendations that include a deeplink from the subset of the plurality of deeplinks that are operating incorrectly,
the notification to the content partner further including an indication of remaining deeplinks that are operating correctly.

3. The method of claim 2, wherein the unified television application presents the recommendations that include one of the remaining deeplinks that are operating correctly.

4. The method of claim 1, wherein the validator is a first validator, the plurality of validators includes a second validator that determines whether to present at least one tile in a row of video tiles within the unified television application for a user having a user account that is authenticated with the unified television application to consume the corresponding video content at a later time.

5. The method of claim 4, wherein the at least one video tile in the row of video tiles corresponds to at least one of a video content item that the user has indicated as being of interest and a video content item that is related to content that the user has consumed.

6. The method of claim 5, wherein the method further comprises determining whether selection of a video tile in the row of video tiles causes the media application to launch and causes the media application to retrieve and play back the video content item corresponding to the video tile.

7. The method of claim 6, wherein the method further comprises determining that the content that the user has consumed is episodic content and determining that the video content item is a subsequent episode of the content that the user has consumed.

8. The method of claim 4, wherein the at least one video tile in the row of video tiles corresponds to video content items that the user has stopped viewing prior to an end time of the video content item.

9. The method of claim 9, wherein the method further comprises determining whether selection of a video tile in the row of video tiles causes the media application to launch and cause the media application to retrieve and play back the video content item corresponding to the video tile from a playback position that corresponds to when the user stopped viewing the video content item.

10. The method of claim 1, wherein the plurality of validators includes a third validator that determines whether the media application transmits an indication of media playback to the unified television application.

11. A system for media application validation, the system comprising:
a server device that includes a hardware processor, wherein the hardware processor is configured to:
receive a media application for presenting video content, the media application being associated with a content partner and the video content being associated with a plurality of media actions that are presented in at least one unified user interface of a unified television application executing on a network-connected television device;
test the media application using a plurality of validators, the plurality of validators configured to test a portion of the plurality of media actions, the plurality of validators including a validator that determines whether a deeplink associated with the video content that is available for presentation using the network-connected television device is operating correctly, and the deeplink, upon selection, causing the media application to launch and cause the media application to retrieve and play back a corresponding video content item;
determine, using the validator, a plurality of deeplinks that are associated with the video content that is available for presentation using the media application, the plurality of deeplinks being presented on at least one unified user interface; and
determine, using the validator, whether selection of the plurality of deeplinks causes the media application to launch and cause the media application to retrieve and play back the corresponding video content item.

12. The system of claim 11, further comprising:
in response to determining that a subset of the plurality of deeplinks are operating incorrectly by not launching the media application and not causing the media application to retrieve and playback the corresponding video content item, transmit a notification to the content partner that the subset of the plurality of deeplinks is operating incorrectly while causing the unified television application to suppress recommendations that include a deeplink from the subset of the plurality of deeplinks that are operating incorrectly.
the notification to the content partner further including an indication of remaining deeplinks that are operating correctly.

13. The system of claim 12, wherein the unified television application presents the recommendations that include one of the remaining deeplinks that are operating correctly.

14. The system of claim 11, wherein the validator is a first validator, the plurality of validators includes a second validator that determines whether to present at least one video tile in a row of video tiles within the unified television application for a user having a user account that is authenticated with the unified television application to consume the corresponding video content at a later time.

15. The system of claim 14, wherein the at least one video tile in the row of video tiles corresponds to at least one of a video content item that the user has indicated as being of interest and a video content item that is related to content that the user has consumed.

16. The system of claim 15, wherein the hardware processor is further configured to determine whether selection of a video tile in the row of video tiles causes the media application to launch and causes the media application to retrieve and play back the video content item corresponding to the video tile.

17. The system of claim 16, wherein the hardware processor is further configured to determine that the content that the user has consumed is episodic content and determining that the video content item is a subsequent episode of the content that the user has consumed.

18. The system of claim 14, wherein the at least one video tile in the row of video tiles corresponds to video content items that the user has stopped viewing prior to an end time of the video content item.

19. The system of claim 18, wherein the hardware processor is further configured to determine whether selection of a video tile in the row of video tiles causes the media application to launch and cause the media application to retrieve and play back the video content item corresponding to the video tile from a playback position that corresponds to when the user stopped viewing the video content item.

20. The system of claim 11, wherein the plurality of validators includes a third validator that determines whether the media application transmits an indication of media playback to the unified television application.

21. A non-transitory computer-readable medium containing computer executable instructions that, when executed by a processor, cause the processor to perform a method for media application validation, the method comprising:
receiving, at a server device, a media application for presenting video content, the media application being associated with a content partner and the video content being associated with a plurality of media actions that are presented in at least one unified user interface of a unified television application executing on a network-connected television device;
testing, at the server device, the media application using a plurality of validators, the plurality of validators configured to test a portion of the plurality of media actions, the plurality of validators including a validator that determines whether a deeplink associated with the video content that is available for presentation using the network-connected television device is operating correctly, and the deeplink, upon selection, causing the media application to launch and cause the media application to retrieve and play back a corresponding video content item;
determining, using the validator, a plurality of deeplinks that are associated with the video content that is available for presentation using the media application, the plurality of deeplinks being presented on at least one unified user interface;
determining, using the validator, whether selection of the plurality of deeplinks causes the media application to launch and cause the media application to retrieve and play back the corresponding video content item.
